(19) United States
(12) Patent Application Publication
(10) Pub. No.: US 2008/0180509 A1
(43) Pub. Date: Jul. 31, 2008

(54) Method of printing two-dimensional code and ink jet printer

(75) Inventor: Yoichiro Maki, Shiojiri-shi (JP)

Correspondence Address: Edwards Angell Palmer & Dodge LLP, P.O. Box 55874, Boston, MA, 02205, US

(73) Assignee: Seiko Epson Corporation, Tokyo (JP)

(21) Appl. No.: 12/011,835

(22) Filed: Jan. 29, 2008

(30) Foreign Application Priority Data
Jan. 29, 2007 (JP) 2007-018458

(51) Int. Cl. B41J 2/01

(52) U.S. Cl. 347/107

(57) ABSTRACT

A method of printing a two-dimensional code using an ink jet printer includes ejecting ink within a predetermined ink ejecting area to form a colored cell constituting the two-dimensional code such that ink bleed adjusting portions are arranged along the outer edge of the ink ejecting area, each ink bleed adjusting portion being a portion where ink is not ejected or a smaller amount of ink than normal amount is ejected.

Priority is claimed under 35 U.S.C. § 119 to Japanese Patent Application JP 2007-018458, which is hereby incorporated by reference in its entirety.

### BACKGROUND

1. Technical Field

The present invention relates to a method of printing a two-dimensional code and an ink jet printer.

2. Related Art

Two-dimensional codes capable of containing information that is several tens to several hundreds of times as much as that contained in a bar code have been known. The known two-dimensional codes include those of a stacked type and those of a matrix type. Examples of the stacked type include PDF417. Examples of the matrix type include a QR code (registered trademark of DENSO WAVE INCORPORATED), DataMatrix, Maxi Code, and Veri Code. The two-dimensional codes need to have an appropriate size and include many black and white cells. For example, regarding a two-dimensional code to be read by a camera-equipped mobile phone, the following design is recommended: A two-dimensional code has a size of 2 cm square and includes a plurality of cells such that the cells ranging in number from 20 to 40 are arranged in each of rows and columns of a matrix. In this case, each cell has a size of fractions of a millimeter. For example, it is assumed that a two-dimensional code has such a pattern that four black cells are located on and under and at the right and left of a first white cell, respectively, four black cells are located on and under and at the right and left of a second white cell, respectively, and four black cells are further located at the upper- and lower-right corners and upper- and lower-left corners of the second white cell, respectively (refer to FIG. 11A). When the above-described two-dimensional code is printed, ink bleeds into each white cell from every direction, thus significantly reducing the area of each white cell. Disadvantageously, a read error may easily occur (refer to FIG. 11B). Japanese Unexamined Patent Application Publication No. 10-49610 (Patent Document 1) discloses a method developed in consideration of the above-described disadvantage. According to this method, an offset value is set in expectation of the amount of change in size of each black cell constituting a two-dimensional code on a printing medium and the two-dimensional code is printed such that the size of each cell in the code is reduced on the basis of the offset value, serving as a parameter. Japanese Unexamined Patent Application Publication No. 2000-203098 (Patent Document 2) discloses a similar printing method.

### SUMMARY

In the use of each of the methods disclosed in the above-described Patent Documents 1 and 2, however, printing a two-dimensional code using an ink jet printer is often less than successful. In printing using the ink jet printer, assuming that a print resolution of 360 dpi is set, a single cell is formed so as to comprise a matrix in which several dots are arranged in each of the rows and columns. Accordingly, it is difficult to perform fine adjustment in order to reduce the cell size. In many cases, the cell size is reduced by one dot. If the extent of ink bleed is substantially equivalent to a single dot size, it is sufficient to reduce the cell size by one dot. However, ink jet printers generally do not always cause ink bleed larger than a print resolution. Accordingly, a blank is formed between black cells after printing (refer to FIG. 11C), thus causing a read error.

An advantage of some aspects of at least one embodiment of the invention is to provide a method of printing a two-dimensional code which hardly causes a read error when being read through a two-dimensional code reader and an ink jet printer.

According to an aspect of at least one embodiment of the invention, there is provided a method of printing a two-dimensional code using an ink jet printer, the method including ejecting ink within a predetermined ink ejecting area to form a colored cell constituting the two-dimensional code such that ink bleed adjusting portions are arranged along the outer edge of the ink ejecting area, each ink bleed adjusting portion being a portion where ink is not ejected or a smaller amount of ink than normal amount is ejected, wherein the ink bleed adjusting portions are placed inside outermost dots arranged in the periphery of the ink ejecting area.

According to this method, ink is ejected within a predetermined ink ejecting area to form a colored cell constituting a two-dimensional code. In other words, according to this method, each colored cell is formed in a two-dimensional code which includes the colored cells and white cells arranged in a matrix. In this instance, ink bleed adjusting portions are arranged along the outer edge of the ink ejecting area. Since each ink bleed adjusting portion is a portion where ink is not ejected or a smaller amount of ink than normal amount is ejected, the ink bleed adjusting portion functions as a retarding basin when ink ejected in the vicinity of the portion bleeds. Consequently, ink ejected in the ink ejecting area hardly bleeds outwardly from the outer edge of the ink ejecting area. Therefore, even if four colored cells are arranged on and under and at the right and left of a white cell, respectively, or eight colored cells are located on and under and at the right and left and at the upper- and lower-right corners and upper- and lower-left corners of a white cell, respectively, the ratio of the area of the white cell to that of each colored cell is not significantly different from an appropriate value. Advantageously, a two-dimensional code, which hardly causes a read error when being read through a two-dimensional code reader, can be printed.

In the method according to this aspect of the invention, the ink bleed adjusting portions may be discontinuously arranged along the outer edge of the ink ejecting area. Advantageously, a reduction in color density of the whole of each ink ejecting area can be prevented and the color density of each ink bleed adjusting portion can be prevented from being lower than that of another colored portion with higher reliability than in a case where ink bleed adjusting portions are arranged continuously.

In the method according to this aspect of the invention, the ink bleed adjusting portions may each have a size equivalent to a single dot. Advantageously, since each ink bleed adjusting portion is sufficiently filled with ink ejected in the vicinity of the portion, the occurrence of a read error can be prevented with higher reliability.

In the method according to this aspect of the invention, when the ink bleed adjusting portions each have a size equivalent to a single dot, a dot formed by ejecting the normal amount of ink may be arranged on each of at least three sides of each ink bleed adjusting portion. In this case, since ink bleeds into each ink bleed adjusting portion from at least three sides of the portion, the ink bleed adjusting portion is easily filled with the ink. One or two dots (colored dots) formed by ejecting the normal amount of ink may be arranged between two adjacent ink bleed adjusting portions. In this instance, ink bleeding from a dot located between two adjacent ink bleed adjusting portions is introduced to the ink bleed adjusting portions. Advantageously, ink can easily be prevented from bleeding outwardly from the outer edge of the ink ejecting area.

In the method according to this aspect of the invention, the ink bleed adjusting portions may be arranged in the periphery of the ink ejecting area. Alternatively, the ink bleed adjusting portions may be arranged inside outermost dots arranged in the periphery of the ink ejecting area. Ink ejected in the periphery of the ink ejecting area tends to bleed outwardly from the outer edge of the ink ejecting area. Since the ink bleed adjusting portions are placed in the periphery of the ink ejecting area or inside outermost dots in the periphery thereof, ink can effectively be prevented from bleeding outwardly from the ink ejecting area.

In the method according to this aspect of the invention, the ink bleed adjusting portions may be arranged in a single line along the outer edge of the ink ejecting area. Advantageously, a reduction in color density of the whole of each ink ejecting-area can be prevented. In other words, when the ink bleed adjusting portions are arranged in more than a single line, the total area of the ink bleed adjusting portions is too large relative to the amount of ejected ink. Disadvantageously, the color density of the whole of the ink ejecting area may be reduced. According to this aspect, since the ink bleed adjusting portions are arranged in a single line, the above disadvantage does not occur.

According to another aspect of at least one embodiment of the invention, a program allows at least one computer to execute the above-described method of printing a two-dimensional code. The program may be recorded on a computer-readable recording medium (for example, a hard disk, a ROM, an FD, a CD, or a DVD) or may be transferred from a computer to another computer through a transmission medium (for example, a communication network, such as the Internet or a LAN) or may be provided in any form. When the program is executed by one computer or is shared by a plurality of computers such that the computers perform respective steps of the program, the same advantages as those of the method according to the foregoing aspect of the invention can be obtained.

According to further another aspect of at least one embodiment of the invention, an ink jet printer for printing a two-dimensional code includes an ink cartridge, a print head that ejects ink supplied from the ink cartridge to a recording medium, and a control unit that controls the print head to eject ink within a predetermined ink ejecting area in order to form a colored cell constituting the two-dimensional code such that ink bleed adjusting portions are arranged along the outer edge of the ink ejecting area, each ink bleed adjusting portion being a portion where ink is not ejected or a smaller amount of ink than normal amount is ejected, wherein the ink bleed adjusting portions are placed inside outermost dots arranged in the periphery of the ink ejecting area.

In the ink jet printer according to this aspect of the invention, ink is ejected within a predetermined ink ejecting area to form a colored cell constituting a two-dimensional code. In this instance, ink bleed adjusting portions are discontinuously arranged along the outer edge of the ink ejecting area. Since each ink bleed adjusting portion is a portion where ink is not ejected or a smaller amount of ink than normal amount is ejected, the ink bleed adjusting portion functions as a retarding basin when ink ejected in the vicinity of the portion bleeds. Advantageously, ink ejected in the ink ejecting area hardly bleeds outwardly from the outer edge of the ink ejecting area. Therefore, even if four colored cells are arranged on and under and at the right and left of a white cell, respectively, or eight colored cells are located on and under and at the right and left and at the upper- and lower-right corners and upper- and lower-left corners of a white cell, respectively, the ratio of the area of the white cell to that of each colored cell is not significantly different from an appropriate value. Consequently, a two-dimensional code, which hardly causes a read error when being read through a two-dimensional code reader, can be printed. The control unit in the ink jet printer according to this aspect of the invention may realize steps included in the method according to the foregoing aspect.

### BRIEF DESCRIPTION OF THE DRAWINGS

The invention will be described with reference to the accompanying drawings, wherein like numbers reference like elements.

FIG. 1 is a schematic diagram illustrating the structure of an ink jet printer 20.

FIG. 2 is a block diagram illustrating electrical connection of a print head 24.

FIG. 3 is a flowchart of a QR code printing routine.

FIG. 4 includes diagrams explaining an example of a QR code.

FIG. 5 includes enlarged views of a part surrounded by an alternate long and short dash line in FIG. 4.

FIG. 6 is an enlarged view of part of a printed QR code.

FIG. 7A to FIG. 7C are diagrams explaining black cells of QR codes in accordance with other embodiments.

FIG. 8 includes enlarged views of part of a QR code according to another embodiment.

FIGS. 9A to 9C are diagrams explaining black cells of QR codes in accordance with other embodiments.

FIG. 10 includes enlarged views of part of a QR code according to another embodiment.

FIGS. 11A to 11C are enlarged views of parts of QR codes.

### DESCRIPTION OF EXEMPLARY EMBODIMENTS

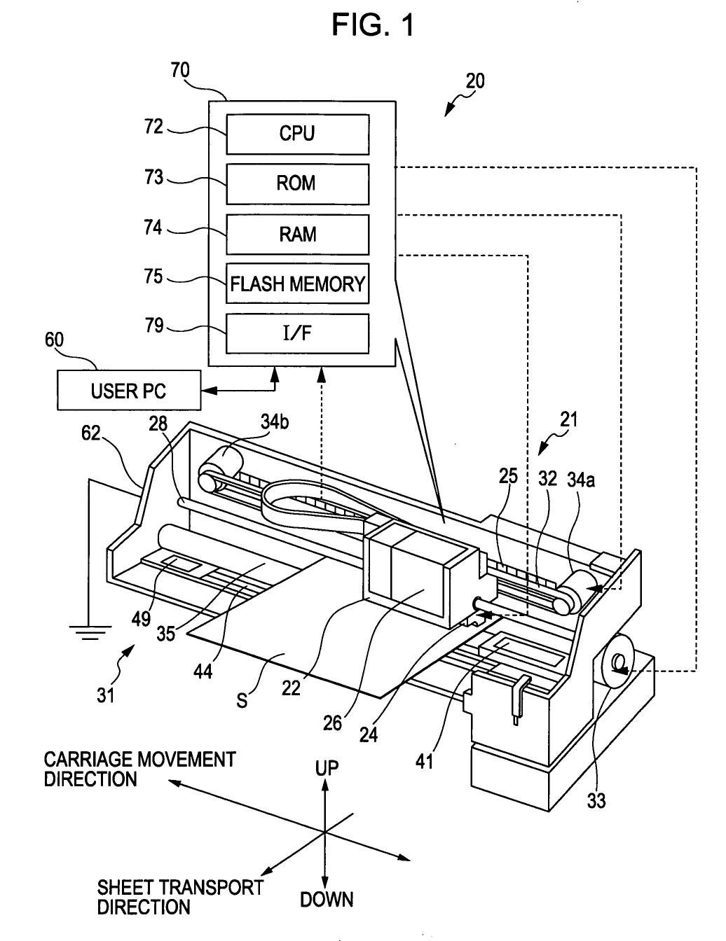

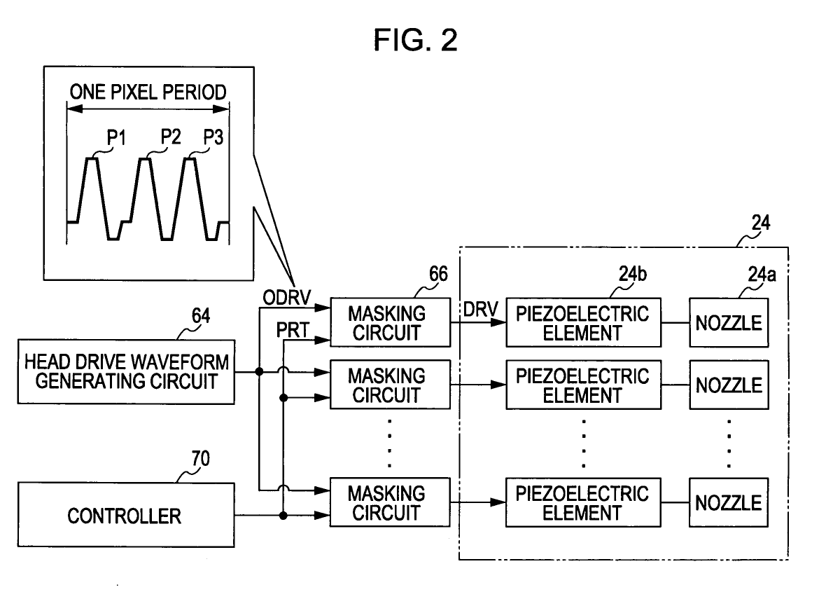

An embodiment of the invention will be described below. FIG. 1 is a schematic diagram of the structure of an ink jet printer 20 according to an embodiment of the invention. FIG. 2 is a block diagram illustrating electrical connection of a print head 24.

Referring to FIG. 1, the ink jet printer 20 according to the present embodiment includes a print mechanism 21, a paper advance mechanism 31, a cap 41, and a controller 70. The print mechanism 21 ejects ink droplets to a recording sheet S, which is transported on a platen 44 from the back to the front in the diagram, to perform printing. The paper advance mechanism 31 includes a paper advance roller 35 driven by a drive motor 33. The cap 41 is arranged in the vicinity of the right end of the platen 44 in FIG. 1. The controller 70 controls the whole of the ink jet printer 20 and corresponds to a control unit.

The print mechanism 21 includes a carriage 22, an ink cartridge 26, and the print head 24. The carriage 22 is reciprocated from side to side along a guide 28 by a carriage belt 32. The ink cartridge 26 is mounted on the carriage 22 and separately contains inks of different colors, i.e., yellow (Y), magenta (M), cyan (C), and black (K). The print head 24 applies pressure to the inks supplied from the ink cartridge 26. The carriage 22 is moved in accordance with the movement of the carriage belt 32 driven by a carriage motor 34a, which is attached to an inner right portion of a mechanical frame 62. The carriage belt 32 is arranged between the carriage motor 34a and a driven roller 34b, which is attached to an inner left portion of the mechanical frame 62. A linear encoder 25 for detecting the position of the carriage 22 is disposed on the rear of the carriage 22. The position of the carriage 22 can be controlled using the linear encoder 25. Although the detailed structure of the ink cartridge 26 is not shown, the ink cartridge 26 is constructed as a container that separately contains printing inks of different colors, i.e., cyan (C), magenta (M), yellow (Y), and black (K), each ink being obtained by mixing a dye, serving as a coloring agent, into water, serving as a solvent. The ink cartridge 26 is detachably mounted on the carriage 22. In addition, a flushing area 49 is arranged to the left of the platen 44 (i.e., outside a printable area of the platen 44). The flushing area 49 is used during a so-called flushing operation of allowing nozzles 24a (see FIG. 2) to eject ink droplets regularly or at predetermined time independently of print data in order to prevent ink at the tip of each nozzle from drying and solidifying. Referring to FIG. 2, the print head 24 includes the nozzles 24a which eject the different colors of inks, respectively, and piezoelectric elements 24b, each serving as a drive element that allows the corresponding nozzle 24a to eject ink droplets. The nozzles 24a are arrayed so as to correspond to the respective colors of inks (not shown). When a voltage is applied to the piezoelectric element 24b disposed in any nozzle 24a, the piezoelectric element 24b is deformed to apply pressure onto the ink in the nozzle 24a, so that the ink is ejected from the nozzle 24a. In this embodiment, the print head 24 uses a method of deforming the piezoelectric elements 24b to apply pressure to the inks. Another method of applying a voltage to a heating resistor (e.g., a heater), heating an ink to generate bubbles, and applying pressure to the ink using the bubbles may be used.

A mechanism for ejecting inks will now be described with reference to FIG. 2. The piezoelectric elements 24b arranged for the respective nozzles 24a are connected to masking circuits 66, respectively. Each masking circuit 66 receives an original signal ODRV, generated by a head drive waveform generating circuit 64, and a print signal PRT sent from the controller 70. The original signal ODRV is generated so as to include a first pulse P1, a second pulse P2, and a third pulse P3 for a period corresponding to one pixel (i.e., a period during which the carriage 22 traverses a single pixel). In this embodiment, the original signal ODRV composed of the three pulses P1 to P3 will be called one-pixel period. When receiving the original signal ODRV and the print signal PRT, each masking circuit 66 outputs at least one of the first to third pulses P1 to P3 as a drive signal DRV to the corresponding piezoelectric element on the basis of the received signals. Specifically, when the masking circuit 66 outputs only the first pulse P1 to the corresponding piezoelectric element 24b, the corresponding nozzle 24a ejects a single shot ink droplet, so that a small-sized dot (small dot) is formed in the recording sheet S. When the masking circuit 66 outputs the first and second pulses P1 and P2 to the corresponding piezoelectric element 24b, the corresponding nozzle 24a ejects two shots of ink droplets, so that a middle-sized dot (middle dot) is formed in the recording sheet S. When the masking circuit 66 outputs the first, second, and third pulses P1, P2, and P3 to the corresponding piezoelectric element 24b, the corresponding nozzle 24a ejects three shots of ink droplets, so that a large-sized dot (large dot) is formed in the recording sheet S. As described above, the ink jet printer 20 can form three different sizes of dots by controlling the amount of ink ejected for one pixel period.

The cap 41 is disposed to the right of the printable area of the platen 44. The cap 41 covers the print head 24 to prevent the nozzles 24a of the print head 24 from drying in, for example, a non-print mode. To clean the print head 24, the print head 24 is covered with the cap 41 and a suction pump (not shown) is inserted into a space formed between the cap 41 and the print head 24 to forcibly suck the inks from the respective nozzles 24a.

Referring to FIG. 1, the controller 70 comprising a microprocessor including a CPU 72 is disposed on a main substrate (not shown) attached to the rear of the mechanical frame 62. The controller 70 further includes a ROM 73 for storing various processing programs, a RAM 74 for temporarily storing data, a flash memory 75 which data can be written to and erased from, an interface (I/F) 79 for transmitting and receiving information to/from an external device, and an input-output port (not shown). The RAM 74 has a print buffer area, in which print data transmitted from a user PC 60 through the I/F 79 is stored. The controller 70 receives a position signal, indicating the position of the carriage 22, sent from the linear encoder 25 through an input port (not shown) and further receives a print job output from the user PC 60 through the I/F 79. In addition, the controller 70 outputs a control signal (e.g., the print signal PRT) for the print head 24, a control signal for the drive motor 33, and a drive signal for the carriage motor 34a through an output port (not shown) and further outputs print status information to the user PC 60 through the I/F 79.

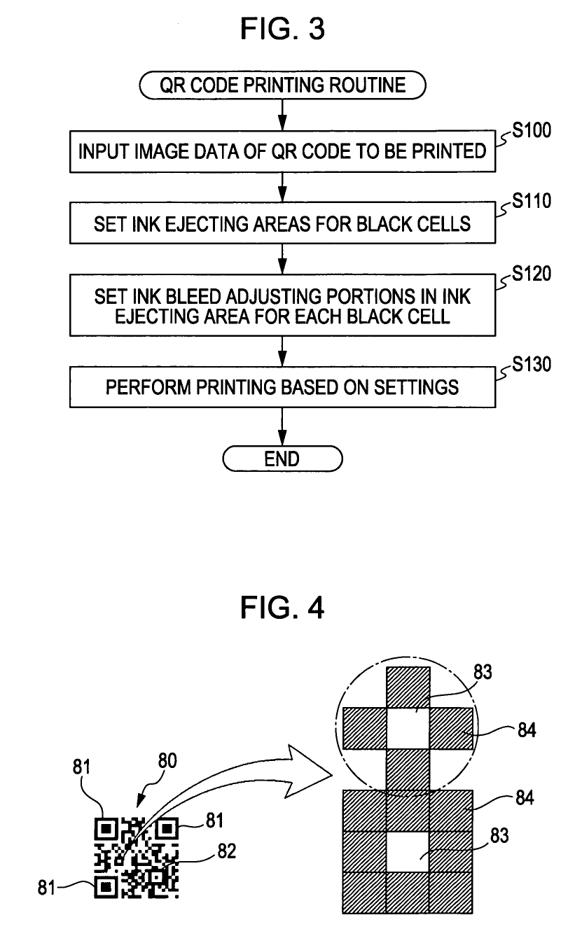

An operation of the ink jet printer 20 according to the embodiment, particularly, an operation of printing a QR code, serving as a two-dimensional code, will be described. FIG. 3 is a flowchart of a QR code printing routine executed by the CPU 72 in the controller 70. This routine is stored in the ROM 73. When a user selects a QR code print mode by operating a mode setting switch (not shown) and gives a print instruction, the CPU 72 executes this routine.

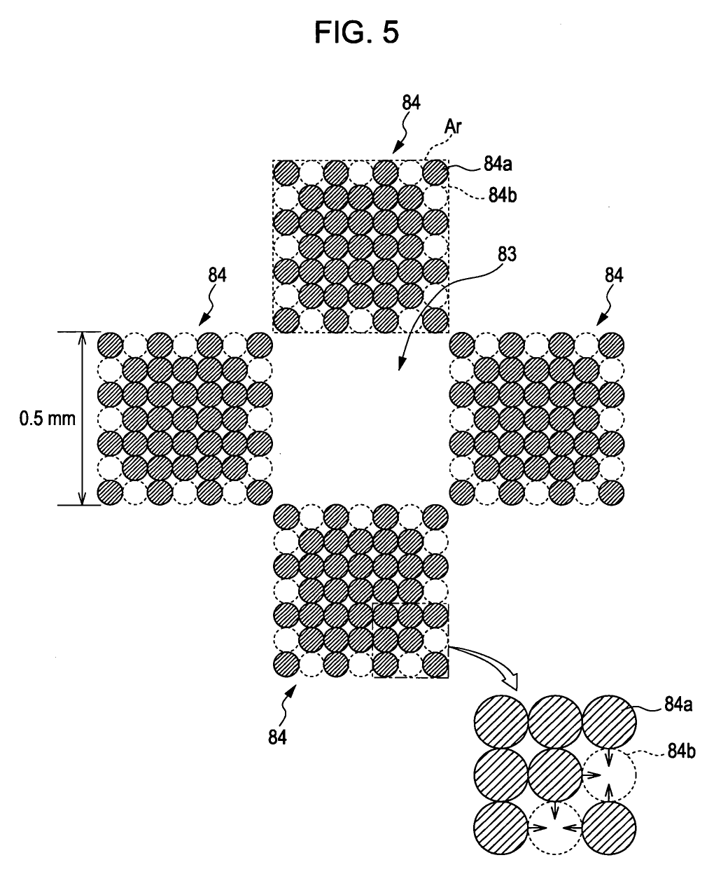

When the QR code printing routine of FIG. 3 is started, the CPU 72 first inputs image data of a QR code to be printed (step S100). FIG. 4 illustrates a QR code. Referring to FIG. 4, a QR code 80 includes symbol segments 81, serving as position detection patterns, an alignment pattern 82, and cells (white cells 83 and black cells 84) each serving as a minimum unit. The symbol segments 81 are arranged at three corners, i.e., the lower-left, upper-left, and upper-right corners of the QR code 80. The alignment pattern 82 is arranged in a lower right portion of the QR code 80 and is used to correct distortion. The QR code 80 represents information, such as numbers, alphabets, or characters, using the white cells 83 and the black cells 84. Referring to FIG. 4, the QR code 80 includes a portion in which four black cells 84 are arranged on and under and at the right and left of a white cell 83 and a portion in which eight black cells 84 are arranged on and under and at the right and left and at the upper- and lower-right and upper- and lower-left corners of another white cell 83 (see a part enlarged view in FIG. 4). Subsequently, areas (hereinafter, ink ejecting areas), in each of which ink is ejected to form a black cell, in the input image data are set (step S110). In this instance, an example of ink ejecting areas is illustrated in FIG. 5. FIG. 5 includes an enlarged view of a part surrounded by an alternate long and short dash line in FIG. 4. Referring to FIG. 5, the cells 83 and 84 each have a design size of 0.5 mm square in which seven dots are arranged in each of the rows and columns. In this case, a square area surrounding all of the dots of each black cell 84 serves as an ink ejecting area Ar. Subsequently, ink bleed adjusting portions are set in each ink ejecting area (step S120). In this instance, an example of ink bleed adjusting portions is illustrated in FIG. 5. Referring to FIG. 5, each black cell 84 is composed of black dots 84a formed by black ink and ink bleed adjusting portions 84b, each having a size equivalent to a single dot and serving as a portion (hereinafter, also referred to as a non-ejecting portion) where ink is not ejected. The ink bleed adjusting portions 84b are arranged in the periphery of each ink ejecting area Ar such that dots and non-ejecting portions are alternately arranged and the black dots 84a are located at the four corners of the area. In other words, the ink bleed adjusting portions 84b are arranged in a single line along the outer edge of each ink ejecting area Ar. The black dots 84a are arranged on three sides of each ink bleed adjusting portion 84b such that the side of the portion 84b corresponding to the outer edge of the ink ejecting area Ar is open. After the ink ejecting areas Ar for the black cells 84 and the ink bleed adjusting portions 84b and the black dots 84a in each ink ejecting area Ar are set as described above, the print mechanism 21 is controlled on the basis of the settings to print the QR code onto the recording sheet S (step S130). The routine then terminates.

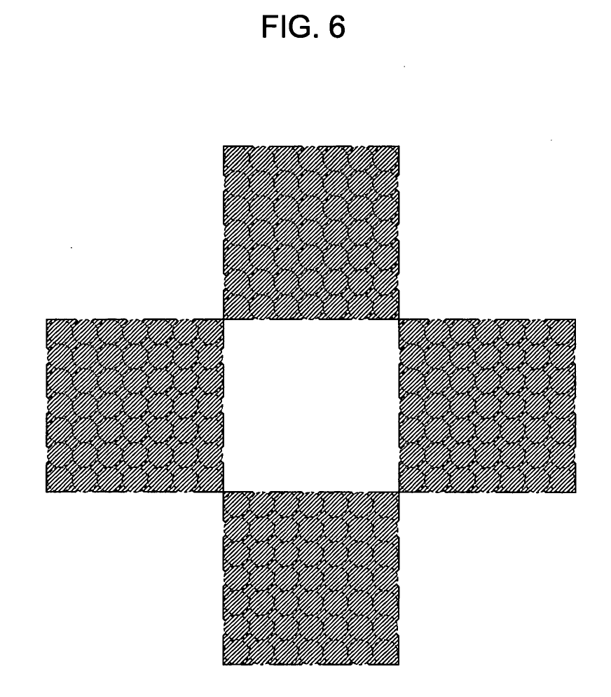

During printing in step S130, ink droplets of black ink (K) are ejected to a portion for each black dot 84a from the corresponding nozzle of the print head 24 so as to form a large dot. The ink droplets are not ejected to a portion corresponding to each ink bleed adjusting portion 84b. In this instance, the ink droplets are ejected to portions on three sides of each of the ink bleed adjusting portions 84b arranged in the periphery of each ink ejecting area Ar. As indicated by arrows in another enlarged view in FIG. 5, the ejected ink tends to bleed only toward the ink bleed adjusting portions 84b until the ink on the recording sheet S dries. In other words, the ink bleed adjusting portions 84b each function as a retarding basin. Consequently, the ink bleed adjusting portions 84b are filled with the black ink ejected to the portions for the black dots 84a arranged in the periphery of each ink ejecting area Ar. Furthermore, the ejected ink hardly spreads outwardly from the outer edge of each ink ejecting area Ar. FIG. 6 is an enlarged view of part of the QR code which has been printed on the recording sheet S according to the above-described routine and in which ink has dried. As is clear from FIG. 6, the ratio of the area of the white cell 83 to that of each black cell 84 is approximately 1:1. Accordingly, when the obtained QR code is read by a QR code reader (not shown), a read error hardly occurs. This advantage is similarly obtained in the case where eight black cells 84 are located on and under and at the right and left and at the upper- and lower-right corners and upper- and lower-left corners of a white cell 83.

As described in detail above, when the ink jet printer 20 according to this embodiment prints the QR code 80 which includes a portion where four black cells 84 are located on and under and at the right and left of a white cell 83 and a portion where eight black cells 84 are arranged on and under and at the right and left and at the upper- and lower-right corners and upper- and lower-left corners of a white cell 83, the ratio of the area of each white cell 83 to that of each black cell 84 is not significantly different from an appropriate value. Advantageously, the ink jet printer 20 can print a QR code (refer to FIG. 6) which hardly causes a read error when being read by a two-dimensional code reader. Since each ink bleed adjusting portion 84b has a size equivalent to a single dot and ink enters the ink bleed adjusting portion 84b from three sides thereof, the ink bleed adjusting portion 84b is sufficiently filled with the ink, so that a blank is hardly formed between the ink bleed adjusting portions 84b and a black dot 84a. Accordingly, a read error hardly occurs.

Furthermore, since ink bleeding from a black dot 84a between two adjacent ink bleed adjusting portions 84b tends to enter the ink bleed adjusting portions 84b and the ink bleed adjusting portions 84b are arranged in the periphery of each ink ejecting area Ar, the ink is prevented from bleeding outwardly from the outer edge of the ink ejecting area Ar. Since the ink bleed adjusting portions 84b are discontinuously arranged in a single line along the outer edge of the ink ejecting area Ar, a reduction in color density of the whole of each ink ejecting area Ar or each ink bleed adjusting portion 84b can be prevented with higher reliability than in a case where ink bleed adjusting portions 84b are arranged continuously or in more than a single line.

It should be understood that the invention is not limited to the above-described embodiment but many modifications and variations are possible within the scope of the invention.

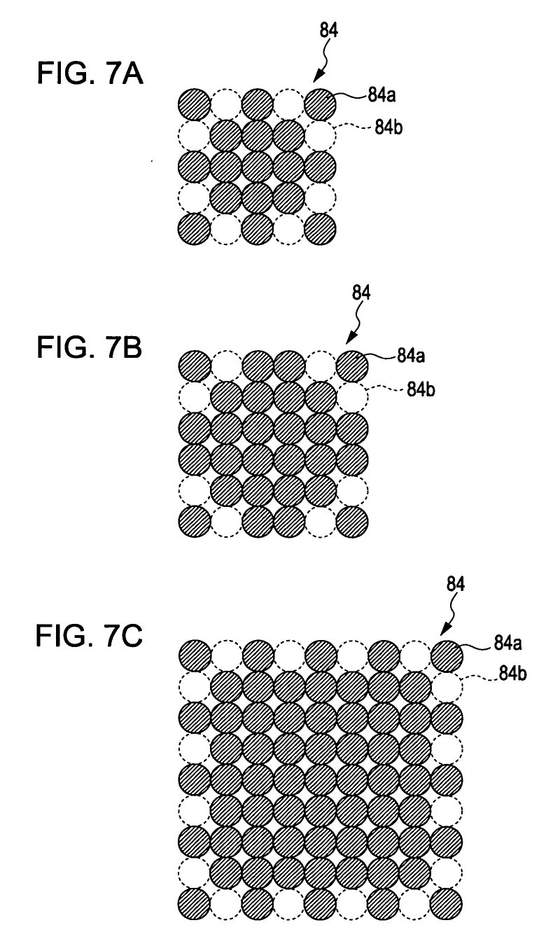

For example, in the above-described embodiment, each black cell 84 includes a matrix in which seven dots are arranged in each of the rows and columns. As shown in FIG. 7A, the black cell 84 may include a matrix in which five dots are arranged in each of the rows and columns. As shown in FIG. 7B, the black cell 84 may include a matrix in which six dots are arranged in each of the rows and columns. As shown in FIG. 7C, the black cell 84 may include a matrix in which nine dots are arranged in each of the rows and columns. When the rows and columns each include odd-numbered dots, such as five dots or nine dots, the black dots 84a are disposed at the four corners of the black cell 84 and the ink bleed adjusting portions 84b are arranged every other dot in a single line in the periphery of the black cell 84. When the rows and columns each include even-numbered dots, e.g., six dots, the black dots 84a are disposed at the four corners of the black cell 84 and the ink bleed adjusting portions 84b are arranged every two dots in a single line in the periphery of the black cell 84. Arrangement of the ink bleed adjusting portions 84b every other dot may be combined with that every two dots depending on the number of dots arranged in each of the rows and columns. Substantially the same advantages as those of the foregoing embodiment are obtained in any of the above-described arrangements.

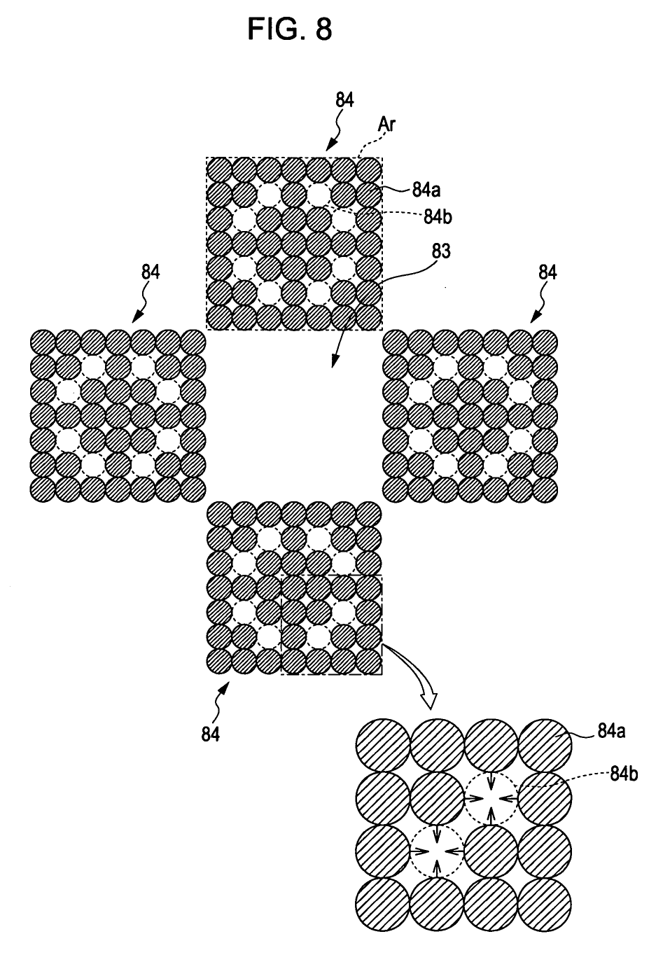

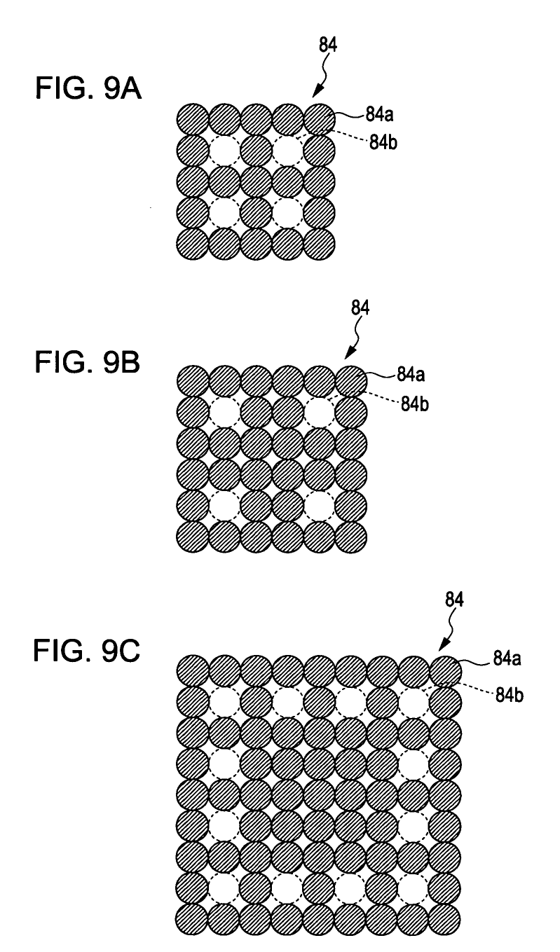

In the foregoing embodiment, the ink bleed adjusting portions 84b are arranged in the periphery of each ink ejecting area Ar. As shown in FIG. 8, the ink bleed adjusting portions 84b may be placed every other dot inside outermost dots arranged in the periphery of the ink jet area Ar. Ink ejected to portions for the outermost black dots 84a in the periphery of each ink ejecting area Ar, serving as a black cell 84, tends to bleed outwardly from the outer edge of the ink ejecting area Ar. However, since the ink bleed adjusting portions 84b are arranged inside the outermost dots in the periphery of the ink jet area Ar, the ink can be effectively prevented from bleeding outwardly from the outer edge of the ink ejecting area Ar. In this case, therefore, substantially the same advantages as those of the foregoing embodiment can be obtained. In FIG. 8, each black cell 84 includes a matrix in which seven dots are arranged in each of the rows and columns. As shown in FIG. 9A, the black cell 84 may include a matrix in which five dots are arranged in each of the rows and columns. As shown in FIG. 9B, the black cell 84 may include a matrix in which six dots are arranged in each of the rows and columns. As shown in FIG. 9C, the black cell 84 may include a matrix in which nine dots are arranged in each of the rows and columns. When the rows and columns each include odd-numbered dots, such as five dots or nine dots, the ink bleed adjusting portions 84b are arranged every other dot in a single line inside the outermost dots placed in the periphery of the black cell 84. When the rows and columns each include even-numbered dots, e.g., six dots, the ink bleed adjusting portions 84b are arranged every two dots in a single line inside the outermost dots in the periphery of the black cell 84. Arrangement of the ink bleed adjusting portions 84b every other dot may be combined with that every two dots depending on the number of dots arranged in each of the rows and columns. Substantially the same advantages as those in FIG. 8 are obtained in any of the above-described arrangements.

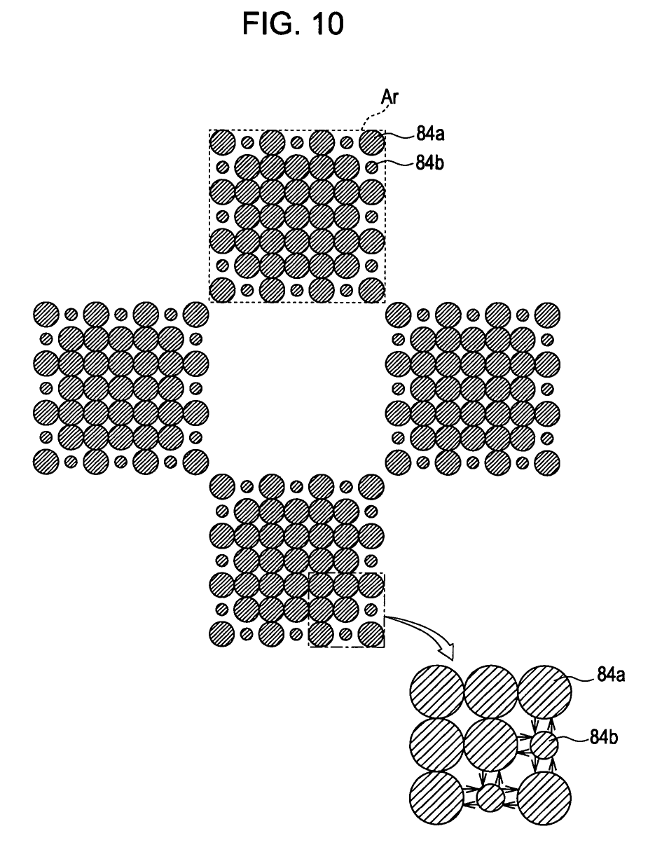

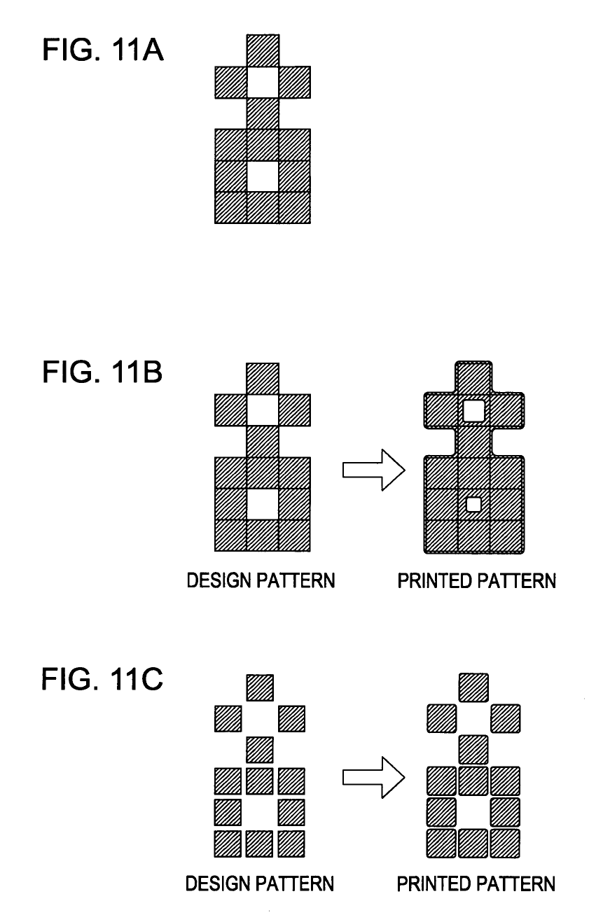

In the foregoing embodiment, each ink bleed adjusting portion 84b is set as a non-ejecting portion where ink is not ejected. As shown in FIG. 10, the ink bleed adjusting portion 84b may be set as a portion where a smaller amount of ink than the normal amount (corresponding to a large dot in this case) is ejected. The ink jet printer 20 can appropriately reduce the original signals ODRV, each including the first to third pulses P1 to P3, to control the amounts of ink to be ejected, thus forming a large dot, a middle dot, and a small dot. When the ink jet printer 20 ejects ink so as to form a middle or small dot in each of the ink bleed adjusting portions 84b arranged in the periphery of each ink ejecting area Ar, each ink bleed adjusting portion 84b has a blank region larger than that of the black dot 84a. The blank region functions as a retarding basin for ink ejected to portions for the black dots 84a disposed on three sides of the ink bleed adjusting portion 84b. Consequently, substantially the same advantages as those in the foregoing embodiment are obtained. In the case where ink is ejected to each ink bleed adjusting portion 84b so as to form a middle or small dot, the ink bleed adjusting portions 84b may be continuously placed along the outer edge of each ink ejecting area Ar.

In the foregoing embodiment, the ink jet printer 20 has been described as an example. The invention may be applied to a multifunction machine that functions as an ink jet printer and further functions as a scanner. In this case, the scanner reads a QR code (two-dimensional code) and a controller analyzes read image data to determine whether the read image data represents a QR code. When it is determined that the read image data represents a QR code, the above-described QR code printing routine in FIG. 3 may be performed to print the read image data through the ink jet printer.

In the foregoing embodiment, QR codes have been described as examples. Another two-dimensional code, for example, a stacked type code, such as PDF417, or a matrix type code, such as DataMatrix, Maxi Code, or Veri Code, may be used.

In the foregoing embodiment, the case using dye ink has been described as an example. The invention may be applied to a case using pigment ink. Pigment ink does not easily bleed as compared to dye ink, but it does experience some ink bleed. Accordingly, the advantages of the invention can be obtained.

What is claimed is:

1. A method of printing a two-dimensional code using an ink jet printer, the method comprising:
ejecting ink within a predetermined ink ejecting area to form a colored cell constituting the two-dimensional code such that ink bleed adjusting portions are arranged along an outer edge of the ink ejecting area, each ink bleed adjusting portion being a portion where ink is not ejected or a smaller amount of ink than normal amount is ejected.

2. The method according to claim 1, wherein the ink bleed adjusting portions each have a size approximately equivalent to a single dot.

3. The method according to claim 2, wherein a dot formed by ejecting the normal amount of ink is arranged on each of at least three sides of each ink bleed adjusting portion.

4. The method according to claim 2, wherein one or two dots formed by ejecting the normal amount of ink are arranged between two adjacent ink bleed adjusting portions.

5. The method according to claim 1, wherein the ink bleed adjusting portions are arranged in a single line along the outer edge of the ink ejecting area.

6. A method of printing a two-dimensional code using an ink jet printer, the method comprising:
ejecting ink within a predetermined ink ejecting area to form a colored cell constituting the two-dimensional code such that ink bleed adjusting portions are arranged along the outer edge of the ink ejecting area, each ink bleed adjusting portion being a portion where ink is not ejected or a smaller amount of ink than normal amount is ejected, wherein
the ink bleed adjusting portions are placed in a periphery of the ink ejecting area.

7. An ink jet printer for printing a two-dimensional code, comprising:
an ink cartridge;
a print head that ejects ink supplied from the ink cartridge to a recording medium; and
a control unit that controls the print head to eject ink within a predetermined ink ejecting area in order to form a colored cell constituting the two-dimensional code such that ink bleed adjusting portions are arranged along an outer edge of the ink ejecting area, each ink bleed adjusting portion being a portion where ink is not ejected or a smaller amount of ink than normal amount is ejected.

8. A method of printing a two-dimensional code using an ink jet printer, the method comprising:
ejecting ink within a predetermined ink ejecting area to form a colored cell constituting the two-dimensional code such that ink bleed adjusting portions are placed inside outermost dots arranged in the periphery of the ink ejecting area, each ink bleed adjusting portion being a portion where ink is not ejected or a smaller amount of ink than normal amount is ejected.

9. The method according to claim 4, wherein when the ink ejecting area includes an even number of rows and columns, two dots formed by ejecting the normal amount of ink are arranged between the ink bleed adjusting portions.

10. The method according to claim 4, wherein when the ink ejecting area includes an odd number of rows and columns, one dot formed by ejecting the normal amount of ink is arranged between the ink bleed adjusting portions.

11. The method according to claim 8, wherein the ink bleed adjusting portions each have a size approximately equivalent to a single dot.

12. The method according to claim 11, wherein one or two dots formed by ejecting the normal amount of ink are arranged between two adjacent ink bleed adjusting portions.

13. The method according to claim 12, wherein when the ink ejecting area includes an even number of rows and columns, two dots formed by ejecting the normal amount of ink are arranged between the ink bleed adjusting portions.

14. The method according to claim 12, wherein when the ink ejecting area includes an odd number of rows and columns, one dot formed by ejecting the normal amount of ink is arranged between the ink bleed adjusting portions.

15. An ink jet printer for printing a two-dimensional code, comprising:
an ink cartridge;
a print head that ejects ink supplied from the ink cartridge to a recording medium; and
a control unit that controls the print head to eject ink within a predetermined ink ejecting area in order to form a colored cell constituting the two-dimensional code such that ink bleed adjusting portions are placed inside outermost dots arranged in periphery of the ink ejecting area, each ink bleed adjusting portion being a portion where ink is not ejected or a smaller amount of ink than normal amount is ejected.

16. The method according to claim 1, wherein the ink bleed adjusting portions are continuously placed along the outer edge of the ink ejecting area.

17. The method according to claim 1, wherein the two-dimensional code is a stacked code selected from a group comprising PDR417, and a matrix-type code.
